(19) United States
(12) Patent Application Publication
(10) Pub. No.: US 2024/0375020 A1
(43) Pub. Date: Nov. 14, 2024

(54) PERSISTENCE OF VISION DISPLAY

(71) Applicant: GODD IP LLC, Lake Geneva, WI (US)

(72) Inventor: Nicholas Grisolia, Lake Geneva, WI (US)

(73) Assignee: GODD IP LLC, Lake Geneva, WI (US)

(21) Appl. No.: 18/657,075

(22) Filed: May 7, 2024

Related U.S. Application Data
(60) Provisional application No. 63/500,661, filed on May 8, 2023.

(51) Int. Cl. A63H 33/22; G09G 3/00

(52) U.S. Cl. CPC A63H 33/22; G09G 3/001

(57) ABSTRACT

The present invention is directed to a persistence of vision display toy that uses flexible fiber optic rods the transfer the light to the ends of the rods to showcase a floating lighting display. The fiber optic rods are also flexible such that distortions are shown in the lighting display when an object disturbs the rotating fiber optic rods.

### CROSS-REFERENCE TO RELATED APPLICATIONS

The present application claim priority to U.S. Provisional Application 63/500,661 filed May 8, 2023.

### FIELD OF THE INVENTION

The present invention is directed to an interactive toy that utilizes a persistence of vision display.

### SUMMARY OF THE INVENTION

There are all kinds of toys that use lights spinning around a center portion to provide various visual displays. These almost always consist of lights fixed on a rotating centered hub. However, the use is not able to interact with the lights, except for the use of buttons or switches to control the display. This invention is directed to providing a new and interesting persistence of vision display toy.

In one embodiment of the invention there is provided a persistence of vision display device defined to include: (a) a base secured to a rotatable element; (b) a programmable circuit board connected to a power supply; (c) an LED board connected to said programmable circuit board; (d) a fiberoptic holder; (e) a plurality of flexible fiber optic rods extending from the fiberoptic holder and each flexible fiber optic rod, of the plurality of flexible fiber optic rods, having an initial stable position that is defined to be substantially straight from its proximal end attached to the fiberoptic holder to its distal free end; (f) a means for spinning the rotatable element; and wherein the programmable circuit board having programmable instructions configured to create an image in the LED board when the base is rotating, such that an image is displayed visually at the distal free ends of the rotating plurality of flexible fiber optic rods, and wherein when a perturbance interferes with the rotating plurality of flexible fiber optic rods, the plurality of flexible fiber optic rods move from the initial stable position to random perturbed positions that cause the image to wobble and distort, and wherein when the perturbance is removed the plurality of fiber optic rods return to the initial stable position.

In a second embodiment there is provided a persistence of vision display device secured to a hand-held fan, the persistence of vision display device being secured over one of the fan blades defined by the hand-held fan; the persistence of vision display device comprising: (a) a base secured to a rotatable element of the hand-held fan; (b) a programmable circuit board connected to a power supply defined by the hand-held fan; (c) an LED board connected to said programmable circuit board; (d) a fiberoptic holder; (e) a plurality of flexible fiber optic rods extending from the fiberoptic holder over one of the fan blades, and each flexible fiber optic rod, of the plurality of flexible fiber optic rods, having an initial stable position that is defined to be substantially straight from its proximal end attached to the fiberoptic holder to its distal free end; and (f) wherein the programmable circuit board having programmable instructions configured to create an image in the LED board when the base is rotating, such that an image is displayed visually at the distal free ends of the rotating plurality of flexible fiber optic rods, and wherein when a perturbance interferes with the rotating plurality of flexible fiber optic rods, the plurality of flexible fiber optic rods move from the initial stable position to random perturbed positions that cause the image to wobble and distort, and wherein when the perturbance is removed the plurality of fiber optic rods return to the initial stable position.

In either embodiment, the persistence of vision display device the image appears to be floating over the base when the display device is rotating. Alternatively, the persistence of vision display device may configure the plurality of flexible fiber optic rods to all have the same height. In other embodiments, the plurality of flexible fiber optic rods may have a variable length such that a profile shape of the plurality of flexible fiber optic rods configured such that said image is translated to the rotation of said profile shape. In a variable length embodiment, the profile shape may be defined as: (i) tapered from one end to another end; (ii) curved outwardly or inwardly from the base; and (iii) having a number of the flexible fiber optic rods are longer then other flexible fiber optic rods.

In any of the embodiments defined herein the persistence of vision display device may include a touch sensor integrated into said programmable circuit board to detect touching of said fiber optic rods. In yet another aspect of the embodiments, the persistence of vision display device may include programming configured to monitor and detect an interference with the rotation of said fiber optic rods, wherein said interference is detected by a sudden change in rotational speed or activation of said touch sensor.

### BRIEF DESCRIPTION OF THE DRAWINGS

A fuller understanding of the foregoing may be had by reference to the accompanying drawings, wherein:

FIGS. 1A-1C shows the persistence of vision display toy in accordance with one embodiment of the invention by illustrating the fiber optic rods extending to a uniform length;

FIGS. 1D-1F shows the persistence of vision display toy form FIG. 1A without the fiberoptic holder and without the plurality of flexible fiber optic rods;

FIG. 2 shows the fiber optic rods in accordance with the embodiment illustrated in FIGS. 1A-1C;

FIGS. 3A-3B illustrate the display device being secured to a rotating fan and illustrate when the device is rotating;

FIGS. 4A-4B illustrate the display device with the fiber optic rods being disturbed;

FIGS. 5A-5B further illustrate the display device with fiber optic rods being disturbed and returning to normal position;

FIGS. 6A-6C illustrate photo images of the display device in use;

FIGS. 7A-7C illustrate in another embodiment, the fiber optic rods having a curved profile;

FIG. 8 illustrate in another embodiment, the fiber optic rods having a tapered profile;

FIG. 9 illustrate in another embodiment, the fiber optic rods having a bowl shape profile;

FIG. 10 illustrate in another embodiment, the fiber optic rods having alternating short and long length; and

FIG. 11 illustrate in another embodiment, a plurality of fibers defined for each one of the fiber optic rods.

### DESCRIPTION OF THE EMBODIMENTS

While the invention is susceptible to embodiments in many different forms, there are shown in the drawings and will described herein, in detail, the preferred embodiments of the present invention. It should be understood, however, that the present disclosure is to be considered an exemplification of the principles of the invention and is not intended to limit the spirit or scope of the invention and the embodiments illustrated.

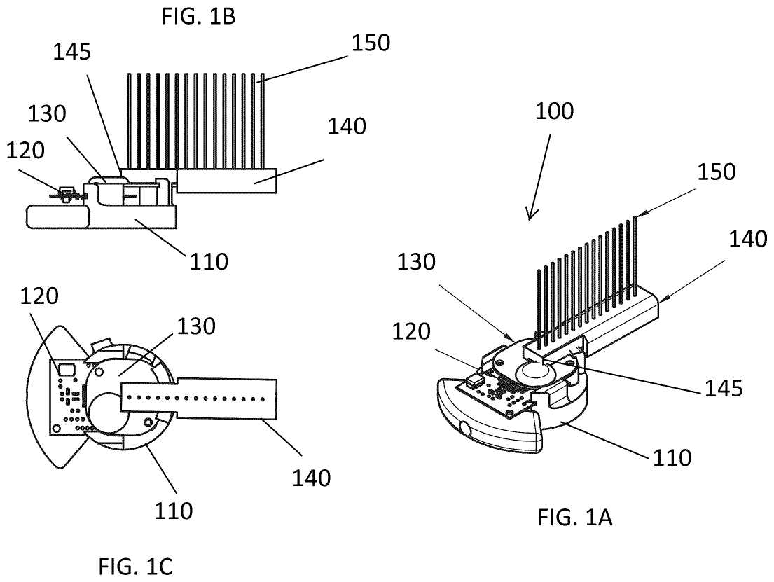

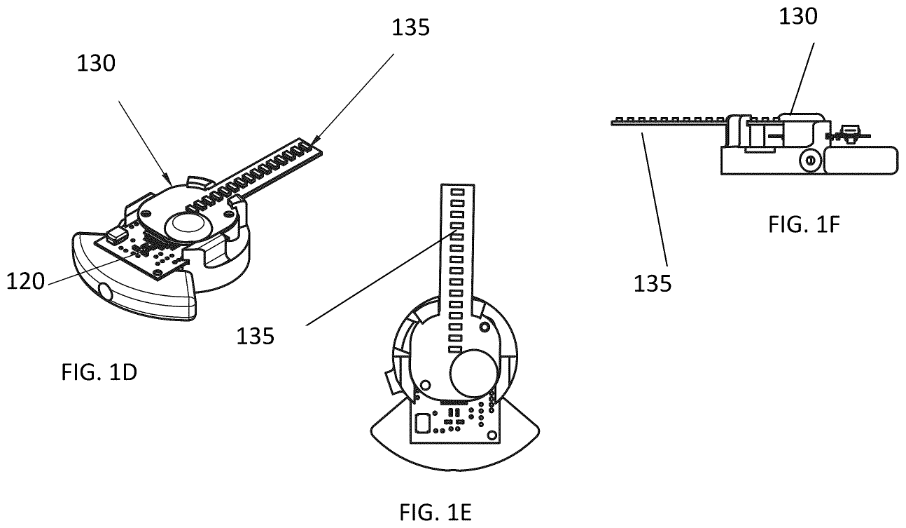

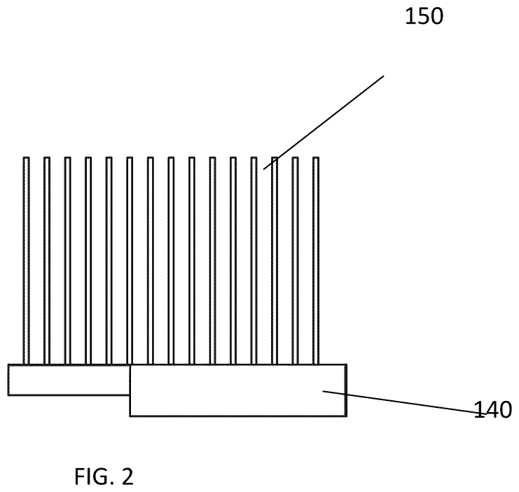

Referring to the drawings in greater detail, namely FIGS. 1A-1F, a persistence of vision display device 100 is illustrated. The display device 100 includes a base 110 used to hold programmable circuit board 120. The board 120 is connected to a power supply (not shown) and an LED board 130. The LED board 130 is a typical board situated with LEDs 135 that are controlled by the circuit board 120. The LED Board 130 is connected to a fiberoptic holder 140 with a plurality of flexible fiber optic rods 150 extending from the fiberoptic holder 140. The fiber optic rods 150 transmit an image that is created by the LED through the fibers to their ends, so the image appears at the ends of the fibers 150.

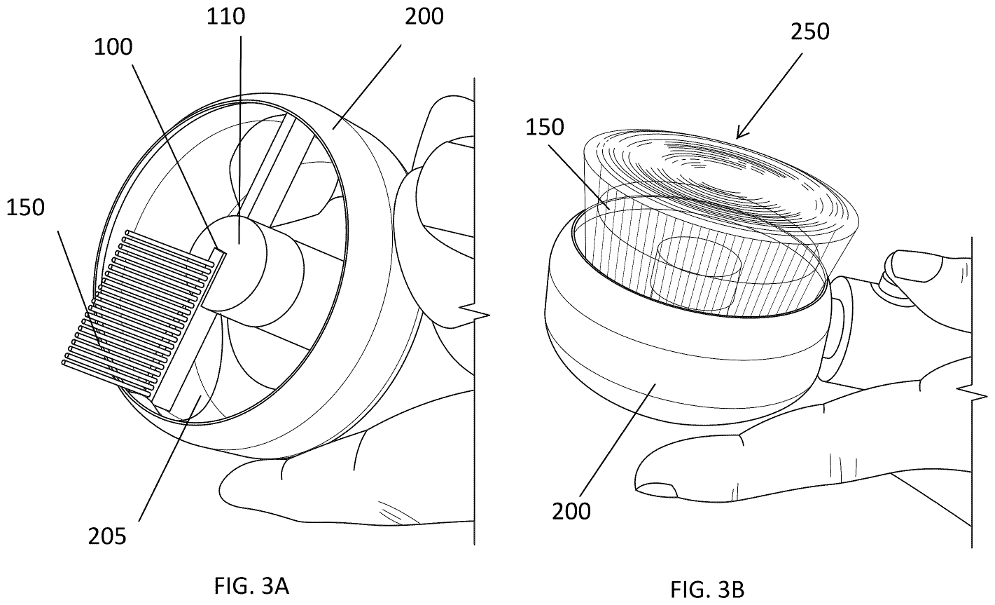

FIG. 2 shows the fiber optic rods 150 secured to the fiberoptic holder 140 and illustrates the rods 150 all being the same height. As shown in FIG. 3A, the display device 100 can be secured to a toy fan 200, where the display device 100 is attached to the rotating center and the fiber optic rods 150 are positioned over one of the fan blades 205. In this instance power to the display device 100 is connected to the power supplied to the toy fan 200.

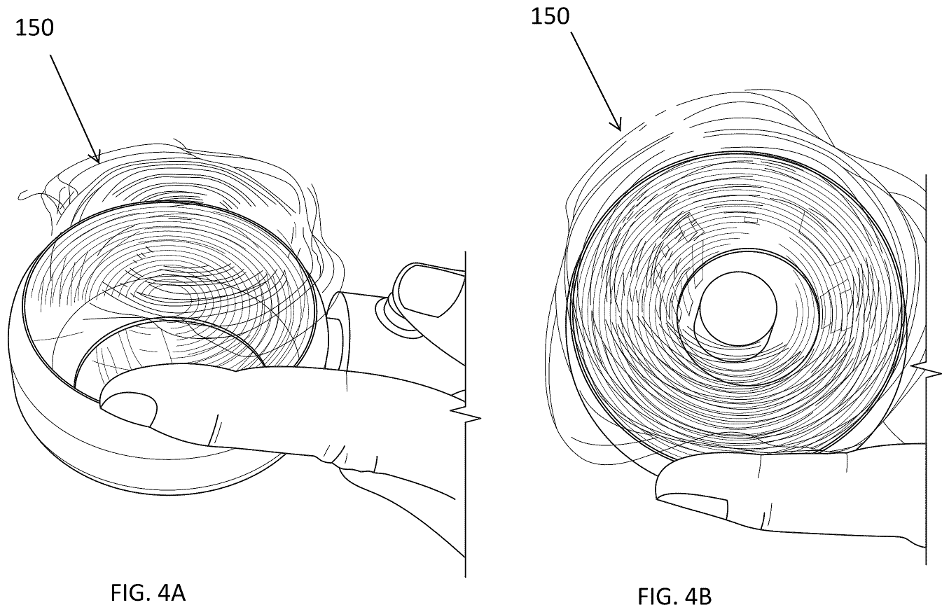

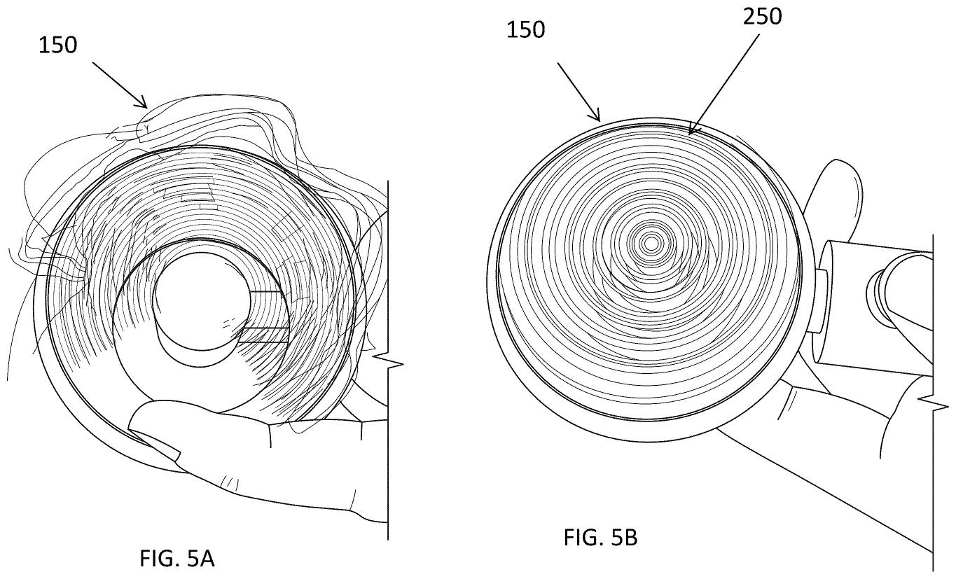

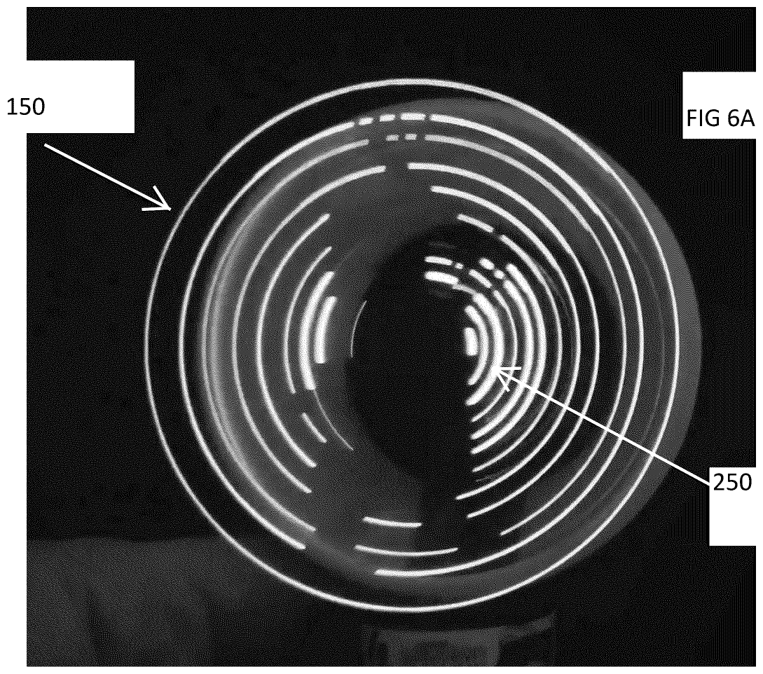

When operating the toy fan rotates the display device 100 and the board 120 activates to create an image 250 through the LEDs which is visible at the end of the fiber optic rods 150. When rotating FIG. 3B, the effect creates an image 250 that appears to be floating over the base 110. Since the fibers are flexible and soft when you place an object like your finger, or a toy figure into the display (FIGS. 4A and 4B) the fibers become perturbed, and causes a warping and bending effect in the image 250. However, as illustrated in FIGS. 5A and 5B when the person's finger or object is removed the fibers 150 return to their nature position and the wrapping disappears causing the image 250 to appear normal.

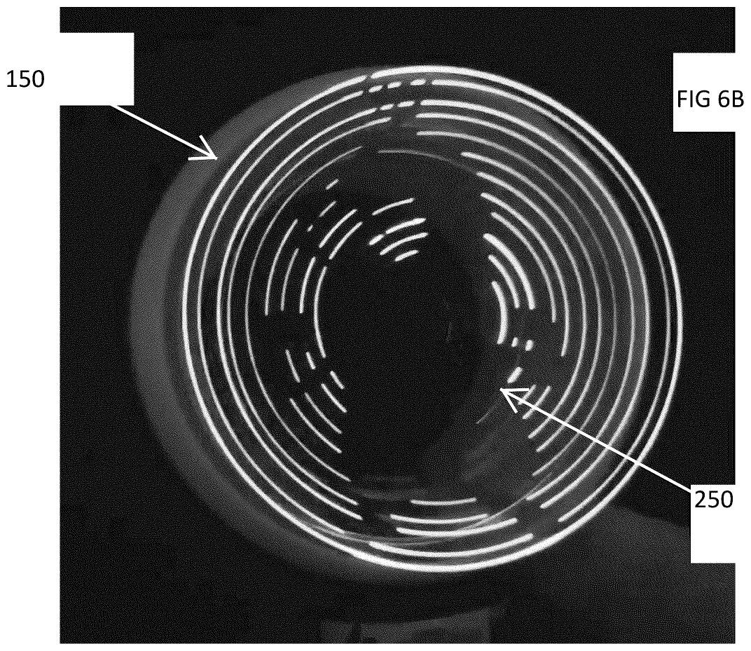

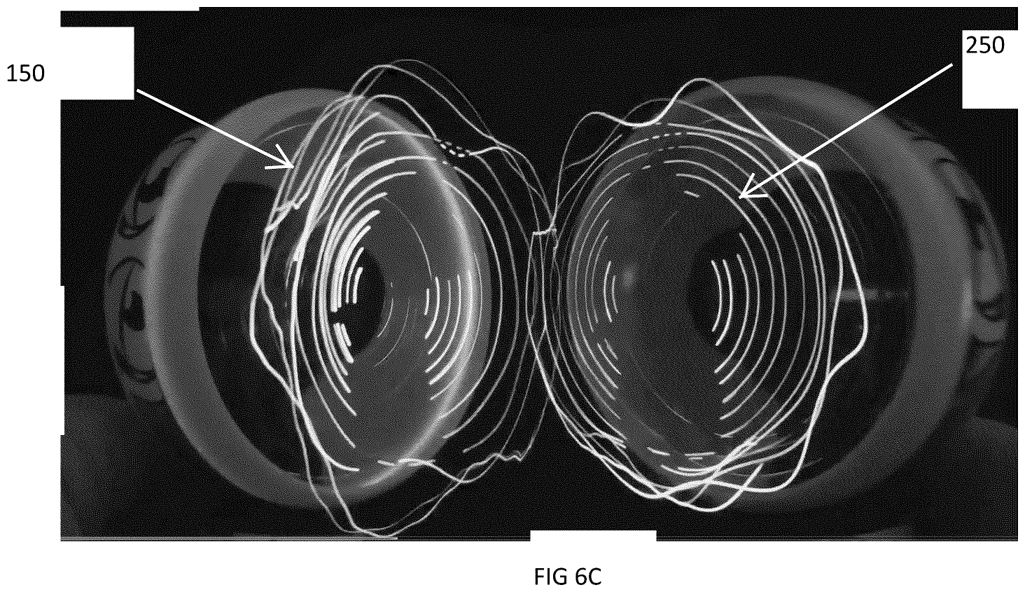

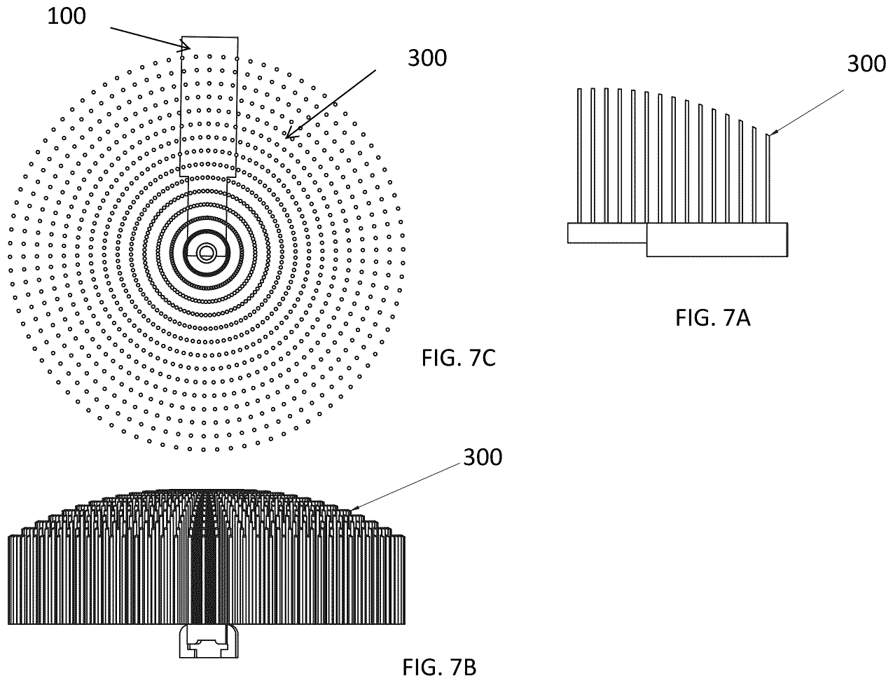

This is further illustrated in the progression images shown in FIGS. 6A through 6C which illustrates the rotating fibers 150 with an image 250 that becomes distorted and wrapped when an object interferes with the rotating fibers 150.

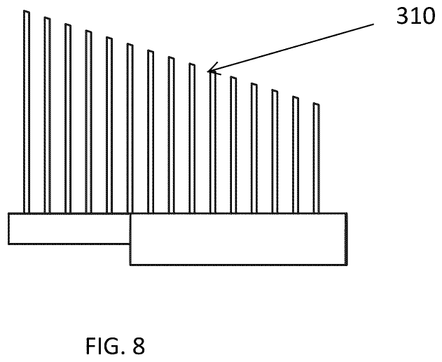

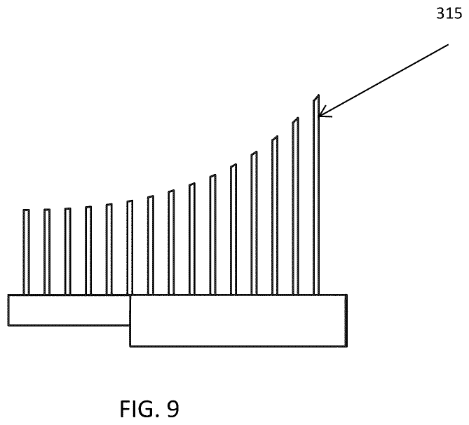

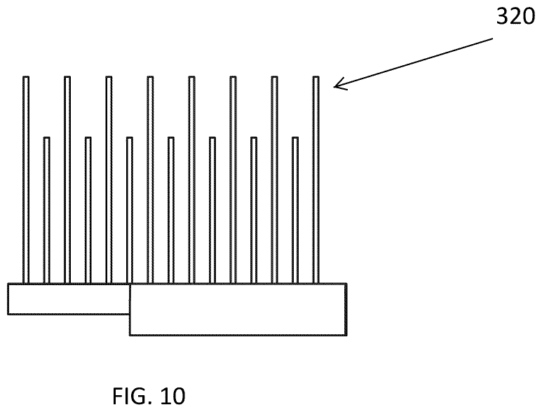

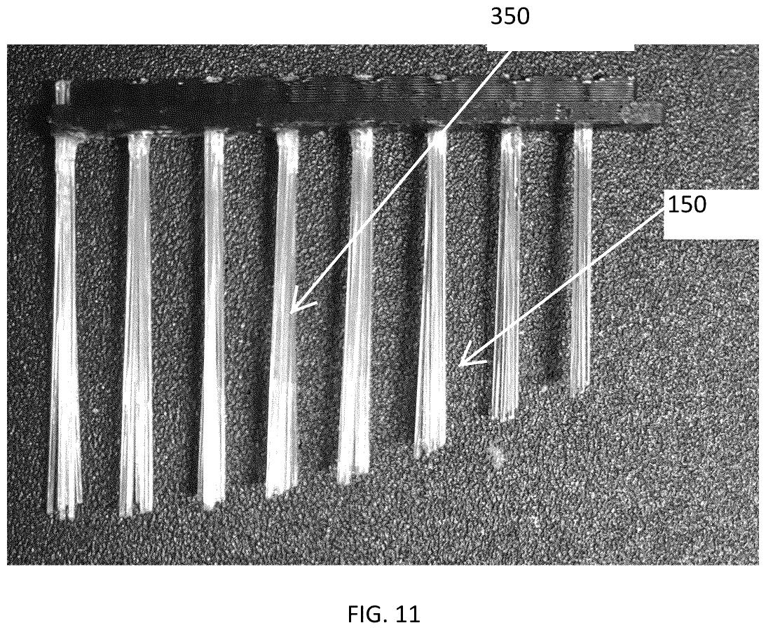

The fibers 150 may also be cut to take on different profile shapes. The image will be translated to the rotation of that shape. So it is possible to shape the fibers in such a manner that when active the display image takes on the shape of a dome, a cone, or wave. FIG. 7A through 7C shown a curved fiber optic profile 300. FIG. 8 shows a tapered fiber optic profile 310. FIG. 9 shows a curved shaped profile 315, which when rotating would appear as a concaved profile. FIG. 10 shows a fiber optic profile 320 that has alternating long and short fiber optic rods. FIG. 11 shows a plurality of fiber optic cables 350 making up each one of the plurality of fiber optic rods 150.

This technique is applicable to any persistence of vision display which is rotating in any orientation, horizontal or vertical. In addition, a touch sensor could be added into the boards to detect touching of the fibers, or the rotational speed of the fibers can be monitored to determine if something is interfering with the rotation. A sudden change of rotational speed or if the touch sensor is activated the device interprets these as a detected touch. When touched the image being displayed can be changed.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

I claim:

1. A persistence of vision display device comprising:
a base secured to a rotatable element;
a programmable circuit board connected to a power supply;
an LED board connected to said programmable circuit board;
a fiberoptic holder;
a plurality of flexible fiber optic rods extending from said fiberoptic holder and each flexible fiber optic rod, of the plurality of flexible fiber optic rods, having an initial stable position that is defined to be substantially straight from its proximal end attached to the fiberoptic holder to its distal free end;
a means for spinning the rotatable element; and
wherein the programmable circuit board having programmable instructions configured to create an image in the LED board when the base is rotating, such that an image is displayed visually at the distal free ends of the rotating plurality of flexible fiber optic rods, and
wherein when a perturbance interferes with the rotating plurality of flexible fiber optic rods, the plurality of flexible fiber optic rods move from the initial stable position to random perturbed positions that cause the image to wobble and distort, and wherein when the perturbance is removed the plurality of fiber optic rods return to the initial stable position.

2. The persistence of vision display device of claim 1, wherein the rotatable element is a fan, and wherein said display device is attached to a rotating center of said fan, and said plurality of flexible fiber optic rods are positioned over a fan blade of said toy fan.

3. The persistence of vision display device of claim 1, wherein said image appears to be floating over said base when said display device is rotating.

4. The persistence of vision display device of claim 1, wherein said plurality of flexible fiber optic rods are all the same height.

5. The persistence of vision display device of claim 1, wherein said plurality of flexible fiber optic rods have a variable length such that a profile shape of the plurality of flexible fiber optic rods configured such that said image is translated to the rotation of said profile shape.

6. The persistence of vision display device of claim 5, wherein the profile shape is tapered from one end to another end.

7. The persistence of vision display device of claim 5, wherein the profile shape is curved outwardly or inwardly from the base.

8. The persistence of vision display device of claim 5, wherein the plurality of flexible fiber optic rods are defined such that a number of the flexible fiber optic rods are longer then other flexible fiber optic rods.

9. The persistence of vision display device of claim 1, further comprising a touch sensor integrated into said programmable circuit board to detect touching of said fiber optic rods.

10. The persistence of vision display device of claim 1, wherein the programmable circuit board include instructions configured to monitor and detect an interference with the rotation of said fiber optic rods, wherein said interference is detected by a sudden change in rotational speed or activation of said touch sensor.

11. A persistence of vision display device secured to a hand-held fan, the persistence of vision display device being secured over one of the fan blades defined by the hand-held fan; the persistence of vision display device comprising:
a base secured to a rotatable element of the hand-held fan;
a programmable circuit board connected to a power supply defined by the hand-held fan;
an LED board connected to said programmable circuit board;
a fiberoptic holder;
a plurality of flexible fiber optic rods extending from said fiberoptic holder over one of the fan blades, and each flexible fiber optic rod, of the plurality of flexible fiber optic rods, having an initial stable position that is defined to be substantially straight from its proximal end attached to the fiberoptic holder to its distal free end; and
wherein the programmable circuit board having programmable instructions configured to create an image in the LED board when the base is rotating, such that an image is displayed visually at the distal free ends of the rotating plurality of flexible fiber optic rods, and
wherein when a perturbance interferes with the rotating plurality of flexible fiber optic rods, the plurality of flexible fiber optic rods move from the initial stable position to random perturbed positions that cause the image to wobble and distort, and wherein when the perturbance is removed the plurality of fiber optic rods return to the initial stable position.

12. The persistence of vision display device of claim 11, wherein said image appears to be floating over said base when said display device is rotating.

13. The persistence of vision display device of claim 12, wherein said plurality of flexible fiber optic rods are all the same height.

14. The persistence of vision display device of claim 11, wherein said plurality of flexible fiber optic rods have a variable length such that a profile shape of the plurality of flexible fiber optic rods configured such that said image is translated to the rotation of said profile shape.

15. The persistence of vision display device of claim 14, wherein the profile shape is tapered from one end to another end.

16. The persistence of vision display device of claim 14, wherein the profile shape is curved outwardly or inwardly from the base.

17. The persistence of vision display device of claim 14, wherein the plurality of flexible fiber optic rods are defined such that a number of the flexible fiber optic rods are longer then other flexible fiber optic rods.

18. The persistence of vision display device of claim 11, wherein the programmable circuit board include instructions configured to monitor and detect an interference with the rotation of said fiber optic rods, wherein said interference is detected by a sudden change in rotational speed or activation of said touch sensor.
